(19) United States
(12) Patent Application Publication
(10) Pub. No.: US 2023/0180716 A1
(43) Pub. Date: Jun. 15, 2023

(54) HORSE BANDAGE

(71) Applicant: Melanie Jayne Davies, Ocala, FL (US)

(72) Inventor: Melanie Jayne Davies, Ocala, FL (US)

(21) Appl. No.: 18/052,035

(22) Filed: Nov. 2, 2022

Related U.S. Application Data
(60) Provisional application No. 63/263,409, filed on Nov. 2, 2021.

(51) Int. Cl. A01K 13/00

(52) U.S. Cl. CPC A01K 13/007

(57) ABSTRACT

A bandage including a front layer of mesh and rear layer of mesh embedded between a top band and a bottom band, the top band with a first elastic band with a first attachment device operative to attaching an end of the first elastic band to an end of the top band, the bottom band with a second elastic band with a second attachment device operative to attaching an end of the second elastic band to an end of the bottom band, and a first binding and a second binding joining the top band and the bottom band, the first binding enclosing a first side of the front layer of mesh and a first side of the rear layer of mesh, and the second binding enclosing a second side of the front layer of mesh and a second side of the rear layer of mesh.

### CROSS-REFERENCE TO RELATED APPLICATION

This application claims the benefit of priority of U.S. provisional application No. 63/263,409, filed Nov. 2, 2021, the contents of which are herein incorporated by reference.

### BACKGROUND OF THE INVENTION

The present invention relates to bandages and, more particularly, to horse bandages.

When a horse is wounded, a bandage must be applied to prevent infections acquired from bugs such as flies or other debris. Presently, horse bandages on the market consist of a wrapping that covers the wound on a horse. These wrappings restrict air flow to the wound. Additionally, wrappings on a joint of the horse fall off or loosen when the horse moves.

As can be seen, there is a need for a horse bandage that protects the wound from bugs and other debris while allowing airflow to encourage healing of the wound and does not fall off with movement.

### SUMMARY OF THE INVENTION

In one aspect of the present invention, a bandage comprises a front layer of mesh and rear layer of mesh embedded between a top band and a bottom band, the top band with a first elastic band with a first attachment device operative to attaching an end of the first elastic band to an end of the top band, the bottom band with a second elastic band with a second attachment device operative to attaching an end of the second elastic band to an end of the bottom band, and a first binding and a second binding joining the top band and the bottom band, the first binding enclosing a first side of the front layer of mesh and a first side of the rear layer of mesh, and the second binding enclosing a second side of the front layer of mesh and a second side of the rear layer of mesh.

These and other features, aspects and advantages of the present invention will become better understood with reference to the following drawings, description, and claims.

### BRIEF DESCRIPTION OF THE DRAWINGS

FIG. 1 is a front view according to an embodiment of the present invention which fits on a knee;

FIG. 2 is a front view thereof shown in use;

FIG. 3 front view according to an embodiment of the present invention which fits on an ankle;

FIG. 4 is a front view thereof shown in use;

FIG. 5 front view according to an embodiment of the present invention which fits on a hock; and

FIG. 6 is a front view thereof shown in use.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

A general overview of the various features of the invention will be provided, with a detailed description following. Broadly, an embodiment of the present invention provides a horse bandage or a wrap configured to cover wounds on an animal such as a horse.

The horse bandage comprises a top band, a bottom band, a front layer of mesh, and a rear layer of mesh. The top band and the bottom band may further comprise elastic bands and an attachment device operative to attaching the elastic band to an end of the band. The attachment device may be a touch fastener, a clip, a button, a zipper, or any other method suitable for fastening the elastic band to the band. In some embodiments, the elastic band may be approximately 2 inches in width and 6 inches in length. The width and length of the elastic bands are not particularly limited by the present invention and any length and width suitable to wrap around an appendage of a horse may be used in the present invention.

As used herein, the term “touch fastener” refers to a hook-and-loop fastener and the like, as well as to the hook portion of the fastener and to the loop portion of the fastener. The hook portion of the fastener and the loop portion of the fastener are reversibly matable.

In some embodiments, the top band may comprise a first elastic band. The bottom band may comprise a second elastic band.

The front layer of mesh and the rear layer of mesh form a double layer of mesh. The double layer of mesh is situated between or embedded between the top band and the bottom band. The front layer of mesh may be tough and durable. In some embodiments, the composition of the front layer of mesh may be a 4 mm polyester hex mesh and 100% polyester. The rear layer of mesh may be softer with a smaller knit. The composition of the rear mesh may be a mesh fabric of approximately 10% spandex and 90% nylon. Any composition suitable to prevent debris from entering the wound while allowing air flow may be used in the present invention. The present invention may comprise a softer rear layer (or inner layer) of mesh which makes contact with the animal or animal's wound while the front layer (outer layer) of mesh withstands the environment.

The top band and the bottom band wrap around an appendage of the horse or animal. The double layer of mesh is positioned on a wound of the horse. A binding may run vertically from the bottom band to the top band securing the mesh to the bands. The binding may be curved in any direction (forward, backward, left, right, upwards, downwards) to best fit an animal appendage. The double layer of mesh protects the wound from flies and debris while allowing air to flow through the double layer. The air promotes healing of the wound.

The composition of the top band and bottom band are not particularly limited by the present invention. The bands may be composed of any material suitable for wrapping around the appendage of a horse. For example, the composition of the bands may be neoprene. The top band may be approximately 4 inches in width and 14 inches in length. The bottom band may be approximately 3 inches in width and 18 inches in length. The length and the width of the bands are not particularly limited by the present invention and any length and width suitable to wrap around an appendage of the horse while holding the mesh may be used in the present invention. The band may be curved in any direction (forward, backward, left, right, upwards, downwards) to best fit an animal appendage.

In some embodiments, the layers of mesh may be embedded between the top band, bottom band, and the bindings. For example, the bands and bindings may each enclose a respective side of the mesh layers. Alternatively, the bands and bindings may surround and each attach to a respective side of the mesh layers.

The bottom band may be a bell boot and fit over a hoof of the horse if the bandage is placed close to the hoof. The bell boot may be a curved band. The bell boot may be composed of any material suitable for wrapping around the appendage of a horse. For example, the composition of the bell boot may be neoprene. The bell boot enables the bandage to more closely fit the hoof of the horse

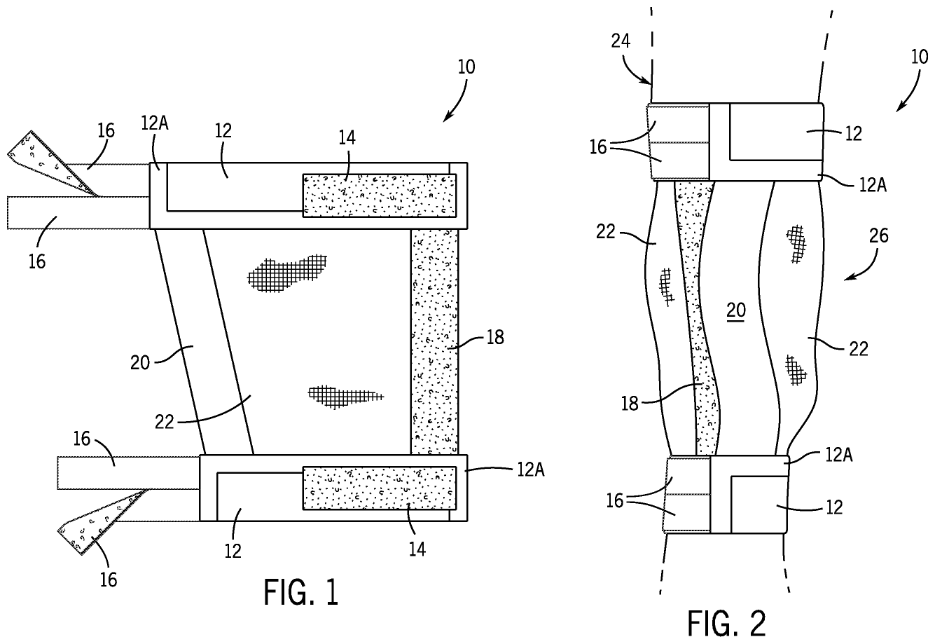

Referring now to the Figures, FIG. 1 shows an embodiment of a first horse bandage 10 that fits on a horse's knee 26. FIG. 2 shows that embodiment in use. A double layer of mesh 22 is between a top neoprene band 12 and a bottom neoprene band 12. Hook fasteners 16 wrap around a horse appendage 24 and connect to loop fasteners 14. A side of the double layer of mesh 22 has a band with a hook fastener backing 20. Another side of the double layer mesh 22 has a band with a loop fastener backing 18. When in use, the band with a hook fastener backing 20 and the band with a loop fastener backing 18 connect. A binding 12A connects the neoprene band 12 to other parts.

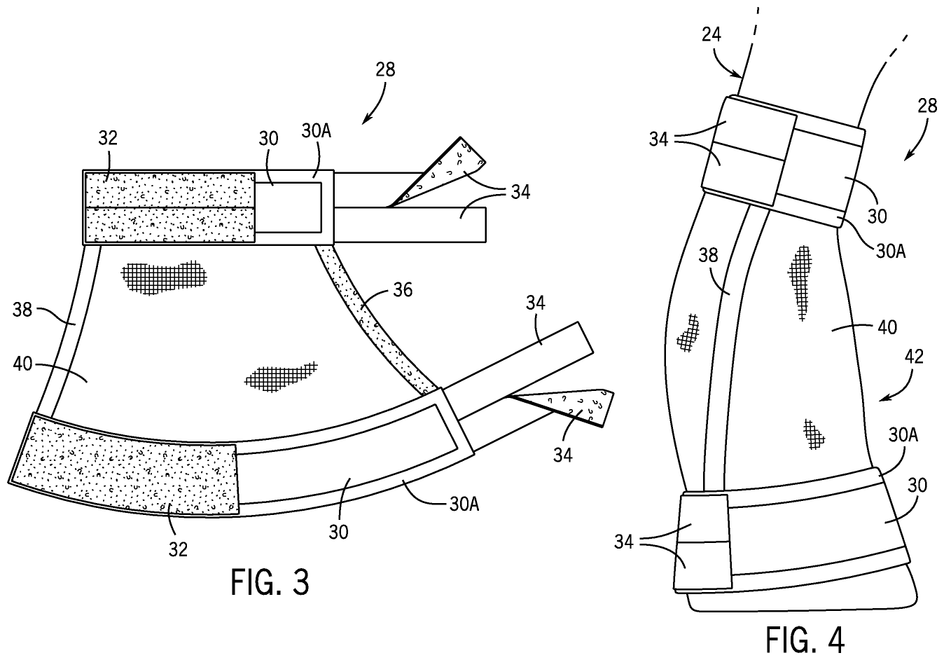

FIG. 3 shows a second embodiment of the horse bandage 28 that fits on a horse's ankle 42. FIG. 4 shows that embodiment in use. A second embodiment of double layer of mesh 40 is between a second embodiment of top neoprene band 30 and a second embodiment of bottom curved neoprene band 30. A second embodiment of hook fasteners 34 wrap around a horse appendage 24 and connect to a second embodiment of loop fasteners 32. A side of the second embodiment of the double layer of mesh 40 has a second embodiment of a band with a hook fastener backing 38. Another side of the second embodiment of the double layer mesh 40 has a band with a second embodiment of a loop fastener backing 36. When in use, the band with a hook fastener backing 38 and the band with a loop fastener backing 36 connect. A binding 30A connects the second embodiment of the neoprene band 30 to other parts.

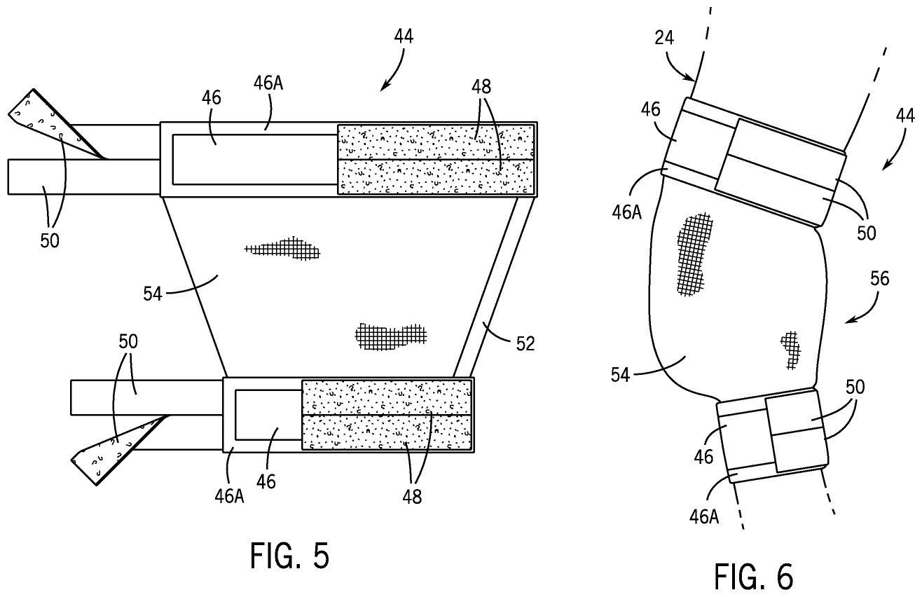

FIG. 5 shows a third embodiment of the horse bandage 44 that fits on a horse's hock 56. FIG. 6 shows that embodiment in use. A third embodiment of double layer of mesh 54 is between a third embodiment of top neoprene band 46 and a third embodiment of bottom neoprene band 46. A third embodiment of hook fasteners 50 wrap around a horse appendage 24 and connect to a third embodiment of loop fasteners 48. A side of the third embodiment of the double layer of mesh 54 has a nylon banding 52. A binding 46A connects the third embodiment of the neoprene band 46 to other parts.

It should be understood, of course, that the foregoing relates to exemplary embodiments of the invention and that modifications may be made without departing from the spirit and scope of the invention as set forth in the following claims.

What is claimed is:

1. A bandage comprising:
a front layer of mesh and rear layer of mesh embedded between a top band and a bottom band;
the top band with a first elastic band with a first attachment device operative to attaching an end of the first elastic band to an end of the top band;
the bottom band with a second elastic band with a second attachment device operative to attaching an end of the second elastic band to an end of the bottom band;
a first binding and a second binding joining the top band and the bottom band;
the first binding enclosing a first side of the front layer of mesh and a first side of the rear layer of mesh; and
the second binding enclosing a second side of the front layer of mesh and a second side of the rear layer of mesh.

2. The bandage of claim 1, wherein the top band is curved to fit an animal appendage.

3. The bandage of claim 1, wherein the bottom band is curved to fit an animal appendage.

4. The bandage of claim 1, wherein the composition of the top band and bottom band are neoprene.

5. The bandage of claim 1, wherein the front layer of mesh is a 4 mm polyester hex mesh and 100% polyester.

6. The bandage of claim 1, wherein the rear layer of mesh is a mesh fabric of approximately 10% spandex and 90% nylon.

7. The bandage of claim 1, wherein the first attachment device and the second attachment device are each a touch fastener.

8. The bandage of claim 1, wherein the first binding and the second binding are neoprene.

9. The bandage of claim 1, wherein the first binding is curved to fit an animal appendage.

10. The bandage of claim 1, wherein the second binding is curved to fit an animal appendage.
